(19) United States
(12) Patent Application Publication
(10) Pub. No.: US 2006/0133113 A1
(43) Pub. Date: Jun. 22, 2006

(54) Backlight module

(75) Inventors: Akio Koike, Miao-Li Hsien (TW); Kinju Taya, Miao-Li Hsien (TW); Chao-Pai Lee, Taichung City (TW)

Correspondence Address: FROMMER LAWRENCE & HAUG, 745 FIFTH AVENUE- 10TH FL., NEW YORK, NY, 10151, US

(73) Assignee: MAIN SOURCE TECHNOLOGY CO., LTD.

(21) Appl. No.: 11/013,723

(22) Filed: Dec. 16, 2004

(51) Int. Cl. F21V 7/04

(52) U.S. Cl. 362/626; 362/625; 362/330

(57) ABSTRACT

A backlight module includes a diffuser, a light guide plate, a reflection sheet, and a light source. The light guide plate includes a top face facing the diffuser, a bottom face opposite to the top face, a light entrance face interconnecting the top and bottom faces and adjacent to the light source, a plurality prismatic strips formed on the top face and extending substantially parallel to each other in a first direction transverse to the light entrance face, and a plurality of spaced apart light deflection protrusions which are arranged in rows along the first direction and each of which tapers outward from the bottom face. The reflection sheet includes a plurality of prismatic strips facing the bottom face of the light guide plate and extending substantially parallel to each other in a second direction transverse to the first direction.

### BACKGROUND OF THE INVENTION

1. Field of the Invention

The invention relates to a backlight module, more particularly to a backlight module which has a relatively simple structure, and which can provide a relatively bright output.

2. Description of the Related Art

Referring to FIGS. 1 and 2, a conventional backlight module includes a light guide plate 1, a light source 2 provided adjacent to the light guide plate 1, a reflection sheet 3 disposed below the light guide plate 1, a first diffuser 4 disposed above the light guide plate 1, a first prism sheet (also known as a prismatic panel) 5 disposed above the first diffuser 4, a second prism sheet 6 disposed above the first prism sheet 5, and a second diffuser 7 disposed above the second prism sheet 6. The light guide plate 1 is used to guide a light incident on an end face proximate to the light source 2 toward an end face distal from the light source 2 via total reflection. In order to form a planar light output on a light exit face 101, a plurality of reflection dots are formed on a bottom face of the light guide plate 1 by printing so as to cause destruction of the total reflection route. Therefore, a part of the light from the light source 2 can exit from the light exit face 101 via diffraction. The reflection sheet 3 is used to reflect the light refracted via the bottom face of the light guide plate 1 back into the light guide plate 1 so as to enhance the light output efficiency. The first diffuser 4 is used to diffuse the light exiting from the light exit face 101 to the first and second prism sheets 5,6. The first and second prism sheets 5,6 respectively are formed with a plurality of prismatic strips. The prismatic strips of the first prism sheet 5 extend substantially parallel to each other in a first direction. The prismatic strips of the second prism sheet 6 extend substantially parallel to each other in a second direction transverse to the first direction. Therefore, the light passing through the first and second prism sheets 5, 6 can be collected and pass through the second diffuser 7 in a predetermined direction so as to diffuse evenly to an LCD panel (not shown).

Although the aforesaid backlight module can convert the light from the light source 2 into a planar light output for subsequent projection onto an LCD panel, two prism sheets 5,6 are required to enhance the brightness of the light supplied to the LCD panel. Therefore, the overall size of the backlight module is relatively large, and the manufacturing cost for the backlight module is relatively high. Furthermore, the dissipation of the light is relatively large because the light travels through a large number of components of the backlight module. Additionally, the reflection dots are printed on the bottom face of the light guide plate 1 for the diffraction of the light so that part of the light can be reflected to exit from the light exit face 101 of the light guide plate 1. However, most of the light will be dissipated due to the diffraction, which can reduce the amount of light that exits the light exit face 101.

Referring to FIG. 3, another conventional backlight module is shown to include a light guide plate 8 having a plurality of prismatic strips provided on the top face thereof, a light source 2 provided adjacent to the light guide plate 8, a reflection sheet 3 disposed below the light guide plate 8, a reverse prism sheet 9 disposed above the light guide plate 8 and having a plurality of prismatic strips on the bottom face thereof, and a diffuser 7 disposed above the reverse prism sheet 9. The prismatic strips of the light guide plate 8 cooperate with the prismatic strips of the reverse prism sheet 9 to correct the direction of the light collection. While the number of the components required for the backlight module is reduced, the reverse prism sheet 9 is required in the backlight module of FIG. 3. Furthermore, the light guide plate 8 is also provided with a plurality of reflection dots (not shown) on the bottom face thereof. Therefore, the disadvantages of the prior art shown in FIGS. 1 and 2 are still present in the backlight module of FIG. 3.

### SUMMARY OF THE INVENTION

Therefore, it is an object of the present invention to provide a backlight module which has a relatively simple and compact structure, and which can provide a relatively bright output and reduce light dissipation.

In one aspect of this invention, a backlight module includes a diffuser, a light guide plate, a reflection sheet, and a light source. The light guide plate includes a top face facing the diffuser, a bottom face opposite to the top face, a light entrance face interconnecting the top and bottom faces, a plurality prismatic strips formed on the top face and extending substantially parallel to each other in a first direction transverse to the light entrance face, and a plurality of spaced apart light deflection protrusions which are arranged in rows along the first direction and each of which tapers outward from the bottom face. The reflection sheet includes a plurality of prismatic strips facing the bottom face of the light guide plate and extending substantially parallel to each other in a second direction transverse to the first direction. The light source is provided adjacent to the light entrance face.

In another aspect of this invention, a light guide plate includes a top surface, a bottom surface opposite to the top surface, alight entrance face interconnecting the top and bottom surfaces, and a plurality of light deflection protrusions protruding from the bottom surface and tapering in a direction away from the bottom face. Each of the light deflection protrusions has a base, a topmost end opposite to the base, a continuous edge extending upward from a first point of the base to the topmost end and turning downward to a second point of the base substantially opposite to the first point, and two opposite deflection surfaces each of which extends from the base to the continuous edge.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional backlight module;

FIG. 2 is an exploded schematic side view of the conventional backlight module of FIG. 1;

FIG. 3 is an exploded perspective view of another conventional backlight module;

FIG. 4 is an exploded perspective view of the preferred embodiment of the backlight module according to this invention;

FIG. 5 is a schematic view of the preferred embodiment;

FIG. 6 is a schematic view of a light guide plate used in the preferred embodiment;

FIG. 7 is a perspective view of a light deflection protrusion of the preferred embodiment;

FIG. 8 is a top view of the light deflection protrusion;

FIG. 9 is a side view of the light deflection protrusion; and

FIG. 10 is another side view of the light deflection protrusion.

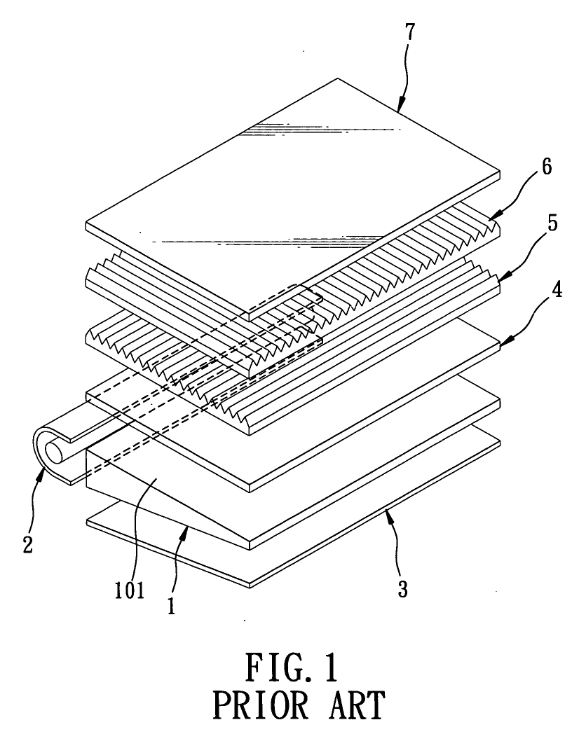

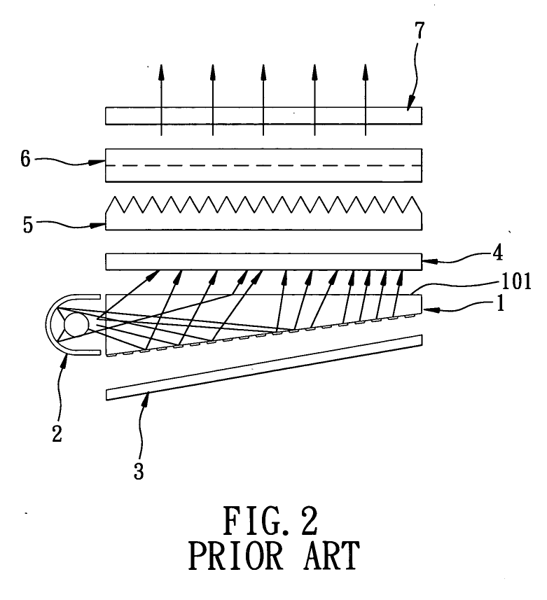

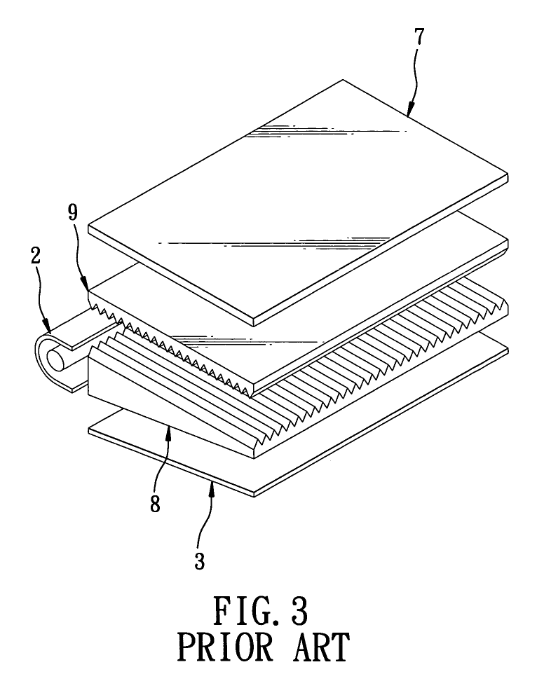

### DETAILED DESCRIPTION OF THE PREFERRED EMBODIMENT

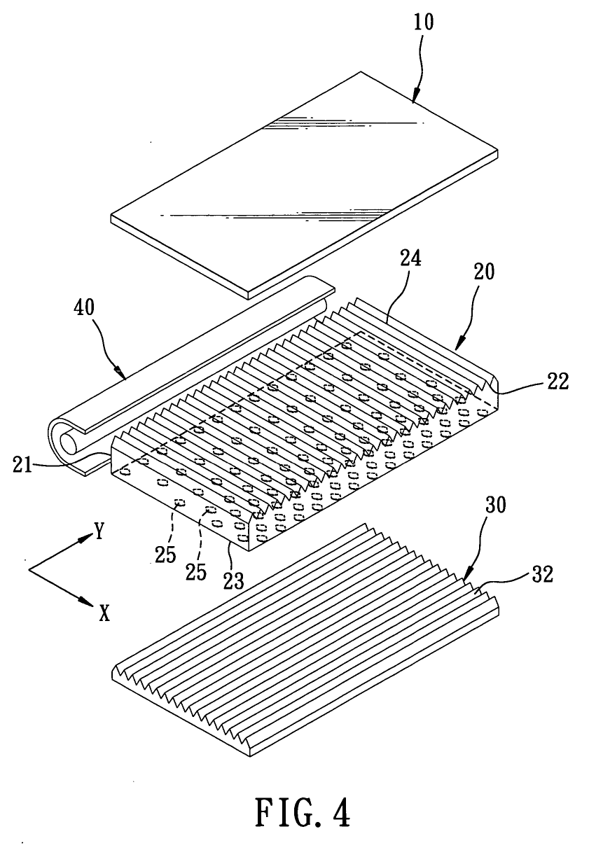

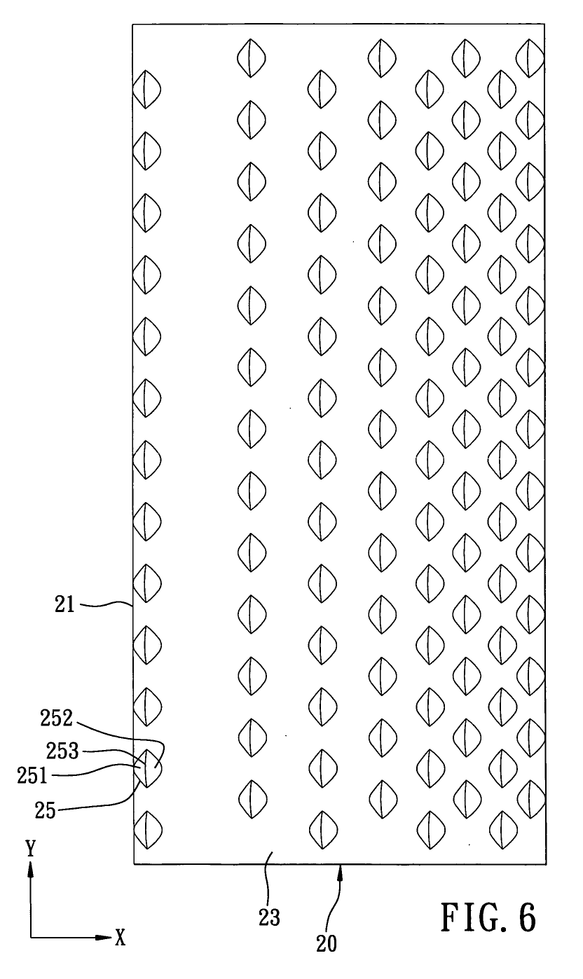

Referring to FIGS. 4, 5, and 6, the preferred embodiment of a backlight module according to this invention is shown to include a diffuser 10, a light guide plate 20, a reflection sheet 30, and a light source 40.

The diffuser 10 is provided on top of the light guide plate 20. The light guide plate 20 includes a top face 22 facing the diffuser 10, a bottom face 23 opposite to the top face 22, a light entrance face 21 interconnecting the top and bottom faces 22,23, a plurality prismatic strips 24 formed on the top face 22 and extending substantially parallel to each other in a first direction (X) transverse to the light entrance face 21, and a plurality of spaced apart light deflection protrusions 25 which are arranged in rows along the first direction (X) and each of which tapers outward from the bottom face 23. The rows of the light deflection protrusions 25 are respectively and substantially aligned with the prismatic strips 24 of the light guide plate 20.

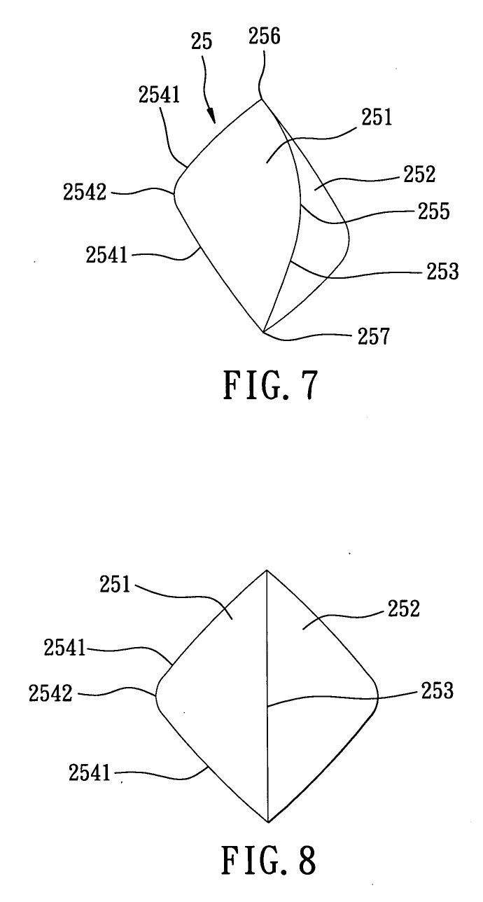

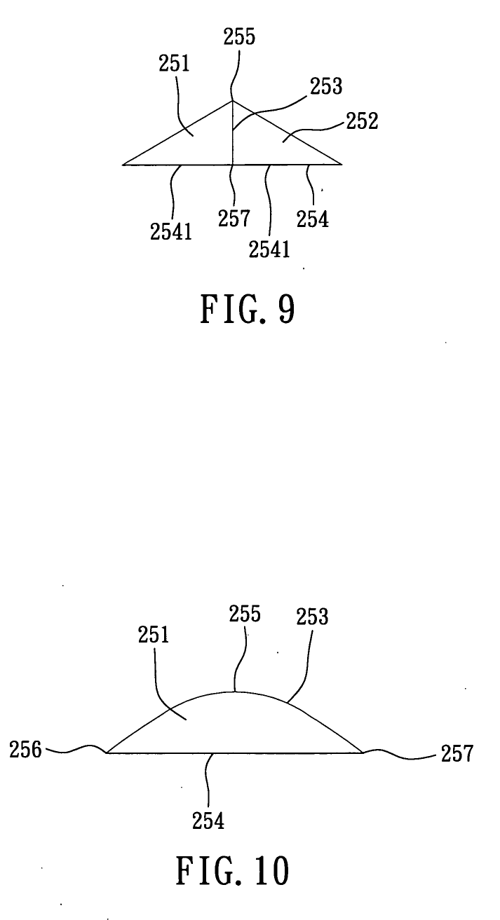

Referring to FIGS. 7, 8, 9, and 10, each of the light deflection protrusions 25 has a base 254, a top most end 255 opposite to the base 254, a continuous edge 253 extending upward from a first point 256 of the base 254 to the topmost end 255 and turning downward to a second point 257 of the base 254 substantially opposite to the first point 256, and first and second deflection surfaces 251,252 opposite to each other. Each of the first and second deflection surfaces 251,252 extends from the base 254 to the continuous edge 253. The first and second deflection surfaces 251,252 are inclined with respect to the bottom face 23, and meet together along the continuous edge 253. The first and second deflection surfaces 251,252 of each of the light deflection protrusions 25 face toward and away from the light entrance face 21, respectively. In this embodiment, the first and second deflection surfaces 251,252 define an angle ranging from 85° to 140° along and adjacent to the continuous edge 253. Preferably, each of the first and second deflection surfaces 251,252 is rounded, and the continuous edge 253 is curved. The base 254 of each of the light deflection protrusions 25 has anon-circular shape, and has two sides 2541 on each side of the continuous edge 253 and a rounded corner 2542 between the two sides 2541. Preferably, the light deflection protrusions 25 increase in density from the light source 40 in the first direction (X) to an end of the light guide plate 20 remote from the light source 40.

The reflection sheet 30 includes a plurality of prismatic strips 32 facing the bottom face 23 of the light guide plate 20 and extending substantially parallel to each other in a second direction (Y) transverse to the first direction (X). The light source 40 is provided adjacent to the light entrance face 21 of the light guide plate 20 for irradiating light into the light guide plate 20.

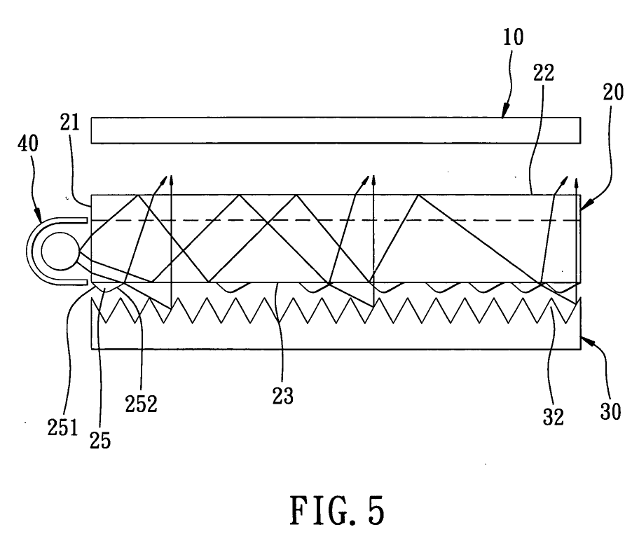

Referring to FIG. 5, the light incident from the light source 40 will be transmitted in the light guide plate 20. The total reflection route will be destructed when the light reaches the light deflection protrusions 25. Furthermore, since the angle between the first and second deflection surfaces 251,252 ranges from 85° to 140°, and since the first and second deflection surfaces 251,252 are smooth, most of the light that reach each of the light deflection protrusions 25 can be reflected upward by the second deflection surfaces 252 so as to exit from the top face 22 of the light guide plate 20. According to actual test results, more than 70% of the light can be reflected upward by the light deflection protrusions 25. Additionally, since the light deflection protrusions 25 increase in density from the light source in the first direction (X) to an end of the light guide plate 20 remote from the light source 40, the luminance distribution is substantially uniform on the top face 22 of the light guide plate 20. Therefore, the quality of light provided by the backlight module is improved.

Furthermore, when the light is reflected by the light deflection protrusions 25 and is subsequently transmitted through the prismatic strips 24 of the light guide plate 20, the cooperative action of the light deflection protrusions 25 and the prismatic strips 24 permits the light to be transmitted through the diffuser 10 in a predetermined direction so as to diffuse the light evenly to an LCD panel (not shown).

Additionally, when the light refracted through the bottom face 23 of the light guide plate 20 reach the prismatic strips 32 of the reflection sheet 30, the light can be reflected by the prismatic strips 32 back into the light guide plate 20 for subsequent transmission to the diffuser 10 through the prismatic strips 24 of the light guide plate 20. Therefore, the cooperative action of the prismatic strips 32 of the reflection sheet 30 and the prismatic strips 24 of the light guide plate 20 permits the light to be transmitted through the diffuser 10 in a predetermined direction so as to diffuse the light evenly to an LCD panel (not shown).

In view of the aforesaid, the backlight module of this invention has the following advantages:

(1) The light guide plate 20 and the reflection sheet 30 of the backlight module of this invention are provided with the prismatic strips 24 and the prismatic strips 32, respectively. As compared to the aforesaid prior art, the backlight module of this invention has a relatively simple and compact structure, and can reduce the manufacturing cost. Additionally, since the traveling route of the light in the backlight module of this invention is reduced due to the simplified structure thereof, the light dissipation effect can be substantially reduced as well.

(2) Since the angle between the first and second deflection surfaces 251,252 of each of the light deflection protrusions 25 ranges from 85° to 140°, and since the first and second deflection surfaces 251,252 of each of the light deflection protrusions 25 are smooth, most of the light that reach the light deflection protrusions 25 can be reflected upward by the second deflection surfaces 252 so as to exit from the top face 22 of the light guide plate 20. Therefore, the utilization efficiency of the light can be improved to increase the brightness of light outputted by the backlight module.

(3) Since the light deflection protrusions 25 increase in density from the light source 40 in the first direction (X) to an end of the light guide plate 20 remote from the light source 40, the luminance distribution is substantially uniform on the top face 22 of the light guide plate 20. Therefore, the quality of the light provided by the backlight module is improved.

(4) When the light refracted through the bottom face 23 of the light guide plate 20 reach the prismatic strips 32 of the reflection sheet 30, the light can be reflected by the prismatic strips 32 back into the light guide plate 20 for subsequent transmission to the diffuser 10 through the prismatic strips 24 of the light guide plate 20. Therefore, the light can be transmitted through the diffuser 10 in a predetermined direction so as to enhance the utilization efficiency of the light.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A backlight module comprising:
a diffuser;
a light guide plate including a top face facing said diffuser, a bottom face opposite to said top face, a light entrance face interconnecting said top and bottom faces, a plurality prismatic strips formed on said top face and extending substantially parallel to each other in a first direction transverse to said light entrance face, and a plurality of spaced apart light deflection protrusions which are arranged in rows along said first direction and each of which tapers outward from said bottom face;
a reflection sheet including a plurality of prismatic strips facing said bottom face of said light guide plate and extending substantially parallel to each other in a second direction transverse to said first direction; and
a light source provided adjacent to said light entrance face.

2. The backlight module as claimed in claim 1, wherein said rows of said light deflection protrusions are respectively and substantially aligned with said prismatic strips of said light guide plate.

3. The backlight module as claimed in claim 1, wherein each of said light deflection protrusions has a base, a topmost end opposite to said base, a continuous edge extending upward from a first point of said base to said topmost end and turning downward to a second point of said base substantially opposite to said first point, and two opposite deflection surfaces each of which extends from said base to said continuous edge.

4. The backlight module as claimed in claim 3, wherein said deflection surfaces define an angle ranging from 85° to 140° along and adjacent to said continuous edge.

5. The backlight module as claimed in claim 3, wherein each of said deflection surfaces is rounded.

6. The backlight module as claimed in claim 3, wherein said continuous edge is curved.

7. The backlight module as claimed in claim 1, wherein said light deflection protrusions increase in density from said light source in said first direction to an end of said light guide plate remote from said light source.

8. The backlight module as claimed in claim 4, wherein said base has a non-circular shape.

9. The backlight module as claimed in claim 8, wherein said base has two sides on each side of said continuous edge, and a rounded corner between said two sides.

10. A light guide plate, comprising:
a top surface;
a bottom surface opposite to said top surface;
a light entrance face interconnecting said top and bottom surfaces; and
a plurality of light deflection protrusions protruding from said bottom surface and tapering in a direction away from said bottom face, each of said light deflection protrusions having a base, a topmost end opposite to said base, a continuous edge extending upward from a first point of said base to said topmost end and turning downward to a second point of said base substantially opposite to said first point, and two opposite deflection surfaces each of which extends from said base to said continuous edge.

11. The light guide plate as claimed in claim 10, wherein said deflection surfaces define an angle ranging from 85° to 140° along and adjacent to said continuous edge.

12. The light guide plate as claimed in claim 10, wherein each of said deflection surfaces is rounded.

13. The light guide plate as claimed in claim 10, wherein said continuous edge is curved.

14. The light guide plate as claimed in claim 11, wherein said base has a non-circular shape.

15. The light guide plate as claimed in claim 14, wherein said base has two sides on each side of said continuous edge, and a rounded corner between said two sides.
